(19) United States
(12) Patent Application Publication
(10) Pub. No.: US 2020/0311321 A1
(43) Pub. Date: Oct. 1, 2020

(54) METHOD FOR DETERMINING REAL-TIME THERMAL DEFORMATION ATTITUDE OF SPINDLE

(71) Applicant: Dalian University of Technology, Dalian City (CN)

(72) Inventors: Kuo LIU, Dalian City (CN); Haibo LIU, Dalian City (CN); Lingsheng HAN, Dalian City (CN); Yongquan GAN, Dalian City (CN); Wei HAN, Dalian City (CN); Te LI, Dalian City (CN); Yongqing WANG, Dalian City (CN)

(21) Appl. No.: 16/603,467

(22) PCT Filed: Feb. 21, 2019
(86) PCT No.: PCT/CN2019/075715

§ 371 Date: Oct. 7, 2019

(30) Foreign Application Priority Data
Jan. 31, 2019 (CN) 201910100942.X

(51) Int. Cl. G06F 30/17; G01N 25/16; G01N 25/18

(52) U.S. Cl. CPC G06F 30/17; G06F 2111/10; G01N 25/18; G01N 25/16

(57) ABSTRACT

The present invention provides a method for determining the real-time thermal deformation attitude of the spindle and it belongs to the technical field of error testing of the CNC machine tools. Firstly, the temperature and the displacement sensors are applied to determine the temperature of the upper and lower surfaces of the spindle box and the radial thermal error of the running spindle, respectively. Then, the thermal variation of the upper and lower surfaces of the spindle box is calculated in accordance with the radial thermal error of the spindle. Then the model for the thermal variation and the temperature of the upper and lower surfaces of the spindle box is established. Finally, the established model is employed to determine the real-time thermal deformation attitude of the spindle, according to the real-time temperatures of the upper and lower surface of the spindle box.

### TECHNICAL FIELD

The invention belongs to the technical field of error testing of the CNC machine tools. More specifically, it relates to a method for determining the real-time thermal deformation attitude of the spindle.

### BACKGROUND

In the machining process of CNC machine tools, thermal deformation is one of the main factors, which adversely affects the machining accuracy. Since the spindle generates a large amount of heat during the operation, the corresponding thermal deformation is also remarkable. The thermal deformation of the spindle not only causes axial thermal elongation errors, but also causes radial thermal drift errors and thermal tilt errors. It should be indicated that these errors adversely affect the relative position of the tool and the workpiece, and the relative attitude of the tool and the workpiece. Therefore, detecting the thermal deformation of the spindle is significant importance to understand the machining accuracy of the machine tool, reduce the scrap rate and provide a database for the analysis and control of the thermal deformation of the spindle. Reviewing the literature indicates that many researches have been conducted to precisely detect the spindle thermal deformation so far.

At present, the thermal error detection of spindles of the CNC machine tool is mainly divided into two categories as the following:

(1) Thermal error detection of the spindle, based on the displacement sensor: Different types of displacement sensors, including the laser, capacitor and the eddy current sensors, can be applied to detect the axial thermal elongation error and the radial thermal drift error during the spindle operation. In the patent Machine tool spindle thermal error monitoring system, whose application number was CN201410064187.1, Yuan et al. applied the laser displacement sensor to detect the thermal error of the spindle. In the patent Test Method for Thermal Error of Machine Tool Spindle under Simulated Load Conditions, whose application number was CN201010292286.7, Gao et al. applied the eddy current sensor to detect the thermal error of the spindle.

(2) Thermal error detection of the spindle, based on the workpiece: In this method, the machining characteristics of the workpieceare utilized to estimate the spindle thermal error. In the patent Measuring and Evaluating Method of Cutting Thermal Error of CNC Machine Tool Based on Milling Small Holes, whose application number was CN201310562312.7, Chou et al. machined a set of small holes on the upper surface of the cube workpiece, and then they detected the spindle thermal error in accordance with the aperture and the hole depth.

Studies show that the existing methods have challenges for detecting the thermal error of the spindle. Although the displacement sensor-based method can accurately detect the thermal drift error and the thermal tilt error of the spindle, however, it can only be applied at no-load conditions, which differs from the actual machining process. On the other hand, although the workpiece-based method can be tested at the actual machining condition, it can only detect the axial thermal drift error of the spindle. In other words, the thermal deformation attitude of the spindle cannot be obtained. It is concluded that the existing methods for detecting the thermal error of the spindle cannot meet the real-time monitoring requirements of the spindle thermal deformation attitude at the machine tool processing state.

### SUMMARY OF THE INVENTION

Considering the constraints of the existing detection methods for monitor the real-time thermal deformation attitude of the spindle at the operating condition of the machine tool, the present invention provides a method for determining the real-time thermal deformation attitude of the spindle.

The technical solution of the invention is as the following:

A method for determining the real-time thermal deformation attitude of a spindle. Firstly, a temperature and a displacement sensors are applied to determine temperature of upper and lower surfaces of a spindle box and radial thermal error of the running spindle, respectively. Then, thermal variation of the upper and lower surfaces of the spindle box is calculated in accordance with the radial thermal error of the spindle. Then a model for the thermal variation and the temperature of the upper and lower surfaces of the spindle box is established. Finally, the established model is employed to determine the real-time thermal deformation attitude of the spindle, according to the real-time temperatures of the upper and lower surface of the spindle box. The specific steps are as follows:

Step 1:Temperature And Thermal Error Testing

A first temperature sensor 1 is located on the upper surface of the spindle box 2, a second temperature sensor 3 is located on the lower surface of the spindle box 2; and moreover, a bar 4 is fixed to the spindle through the shank interface. A first displacement sensor 6 and a second displacement sensor 5 are installed on the side of the bar 4, wherein the second displacement sensor 5 is close to the nose end of the spindle.

The testing process can be described as follows: Firstly, the spindle is continuously heated by running M hours (e.g. 4 hours) at the speed of R (not higher than the maximum speed of the spindle), and then the spindle stops rotating for N hours (e.g. 3 hours). In this process, the data obtained from the first temperature sensor 1, the second temperature sensor 3, the first displacement sensor 6 and the second displacement sensor 5 are collected in a certain period (e.g. 10 seconds).

The second step is to establish the model for the thermal variation and the temperature of the upper and lower surfaces of the spindle box.

The collected data from the first temperature sensor 1 and second temperature sensor 3 are called t₁ and t₂, respectively. On the other hand, the collected data from the first displacement sensor 6 and second displacement sensor 5 are represented by p₁ and p₂, respectively. The increment of t₁, t₂, p₁ and p₂ are expressed in equation (1).

$$\{ \begin{matrix}Δ {t}_{1} ( i ) = {t}_{1} ( i ) - {t}_{1} ( 1 ) \\ Δ {t}_{2} ( i ) = {t}_{2} ( i ) - {t}_{2} ( 1 ) \\ Δ {p}_{1} ( i ) = {p}_{1} ( i ) - {p}_{1} ( 1 ) \\ Δ {p}_{2} ( i ) = {p}_{2} ( i ) - {p}_{2} ( 1 )\end{matrix} \qquad ( 1 )$$

Assume that the distance from the upper surface to the lower surface of the spindle box 2 is A₁, while the distance from the lower surface of spindle box 2 to the second displacement sensor is A₂. Moreover, assume that the distance from the second displacement sensor 5 to the first displacement sensor 6 is A₃.

(1) Calculate the thermal expansion amount of the upper and lower surfaces of the spindle box.

According to the spindle structure, Δp₁ and Δp₂, the thermal variation of the upper surface eᵤₚₚₑᵣ and that of the lower surface e_{lower} can be calculated through the following method.

Intermediate variables α and β are defined as:

$$\{ \begin{matrix}α ( i ) = Δ {t}_{1} ( i ) - Δ {t}_{2} ( i ) \\ β ( i ) = \vert \frac{{A}_{3} \times Δ {t}_{2} ( i )}{α ( i )} \vert\end{matrix} \qquad ( 2 )$$

According to the relationship between α, β, Δp₁ and Δp₂ at the current time, the thermal variation on the upper and lower surfaces of the spindle box at the current time is calculated as follows.

a) when Δp₁(i)≥0, Δp₂(i)≥0, Δp₁(i)>Δp₂(i), β(i)≤A₂:

$$\{ \begin{matrix}{e}_{upper } ( i ) = \vert \frac{( {A}_{1} + {A}_{2} ) \times α ( i ) - {A}_{3} \times Δ {p}_{2} ( i )}{{A}_{3}} \vert \\ {e}_{lower} ( i ) = \vert \frac{{A}_{2} \times α ( i ) - {A}_{3} \times Δ {p}_{2} ( i )}{{A}_{3}} \vert\end{matrix} \qquad ( 3 )$$

b) when Δp₁(i)≥0, Δp₂(i)≥0, Δp₁(i)>Δp₂(i), β(i)>A₂, β(i)≤(A₁+A₂):

$$\{ \begin{matrix}{e}_{upper} ( i ) = \vert \frac{( {A}_{1} + {A}_{2} ) \times α ( i ) - {A}_{3} \times Δ {p}_{2} ( i )}{{A}_{3}} \vert \\ {e}_{lower} ( i ) = - \vert \frac{{A}_{3} \times Δ {p}_{2} ( i ) - {A}_{2} \times α ( i )}{{A}_{3}} \vert\end{matrix} \qquad ( 4 )$$

c) when Δp₁(i)≥0, Δp₂(i)≥0, Δp₁(i)>Δp₂(i), β(i)>(A₁+A₂):

$$\{ \begin{matrix}{e}_{upper} ( i ) = \vert \frac{{A}_{3} \times Δ {p}_{2} ( i ) - ( {A}_{1} + {A}_{2} ) \times α ( i )}{{A}_{3}} \vert \\ {e}_{lower} ( i ) = - \vert \frac{{A}_{3} \times Δ {p}_{2} ( i ) - {A}_{2} \times α ( i )}{{A}_{3}} \vert\end{matrix} \qquad ( 5 )$$

d) when Δp₁(i)≥0, Δp₂(i)≥0, Δp₁(i)≤Δp₂(i):

$$\{ \begin{matrix}{e}_{upper} ( i ) = - \vert \frac{{A}_{3} \times Δ {p}_{2} ( i ) + ( {A}_{1} + {A}_{2} ) \times α ( i )}{{A}_{3}} \vert \\ {e}_{lower} ( i ) = - \vert \frac{{A}_{3} \times Δ {p}_{2} ( i ) + {A}_{2} \times α ( i )}{{A}_{3}} \vert\end{matrix} \qquad ( 6 )$$

e) when Δp₁(i)>0, Δp₂(i)<0:

$$\{ \begin{matrix}{e}_{upper} ( i ) = \vert \frac{{A}_{3} \times \vert Δ {p}_{2} ( i ) \vert + ( {A}_{1} + {A}_{2} ) \times α ( i )}{{A}_{3}} \vert \\ {e}_{lower} ( i ) = \vert \frac{{A}_{3} \times \vert Δ {p}_{2} ( i ) \vert + {A}_{2} \times α ( i )}{{A}_{3}} \vert\end{matrix} \qquad ( 7 )$$

f) when Δp₁(i)<0, Δp₂(i)>0:

$$\{ \begin{matrix}{e}_{upper} ( i ) = - \vert \frac{{A}_{3} \times Δ {p}_{2} ( i ) + ( {A}_{1} + {A}_{2} ) \times α ( i )}{{A}_{3}} \vert \\ {e}_{lower} ( i ) = - \vert \frac{{A}_{3} \times Δ {p}_{2} ( i ) + {A}_{2} \times α ( i )}{{A}_{3}} \vert\end{matrix} \qquad ( 8 )$$

g) when Δp₁(i)<0, Δp₂(i)<0, Δp₁(i)≥Δp₂(i):

$$\{ \begin{matrix}{e}_{upper} ( i ) = \vert \frac{{A}_{3} \times \vert Δ {p}_{2} ( i ) \vert + ( {A}_{1} + {A}_{2} ) \times α ( i )}{{A}_{3}} \vert \\ {e}_{lower} ( i ) = \vert \frac{{A}_{3} \times \vert Δ {p}_{2} ( i ) \vert + {A}_{2} \times α ( i )}{{A}_{3}} \vert\end{matrix} \qquad ( 9 )$$

h) when Δp₁(i)<0, Δp₂(i)<0, Δp₁(i)<Δp₂(i), β(i)>(A₁+A₂):

$$\{ \begin{matrix}{e}_{upper} ( i ) = \vert \frac{{A}_{3} \times \vert Δ {p}_{2} ( i ) \vert - ( {A}_{1} + {A}_{2} ) \times α ( i )}{{A}_{3}} \vert \\ {e}_{lower} ( i ) = \vert \frac{{A}_{3} \times \vert Δ {p}_{2} ( i ) \vert - {A}_{2} \times α ( i )}{{A}_{3}} \vert\end{matrix} \qquad ( 10 )$$

i) when Δp₁(i)<0, Δp₂(i)<0, Δp₁(i)<Δp₂(i), β(i)<(A₁+A₂), β(i)>A₂:

$$\{ \begin{matrix}{e}_{upper} ( i ) = - \vert \frac{( {A}_{1} + {A}_{2} ) \times α ( i ) - {A}_{3} \times \vert Δ {p}_{2} ( i ) \vert}{{A}_{3}} \vert \\ {e}_{lower} ( i ) = \vert \frac{{A}_{3} \times \vert Δ {p}_{2} ( i ) \vert - {A}_{2} \times α ( i )}{{A}_{3}} \vert\end{matrix} \qquad ( 11 )$$

j) when Δp₁(i)<0, Δp₂(i)<0, Δp₁(i)<Δp₂(i), β(i)≤A₂:

$$\{ \begin{matrix}{e}_{upper} ( i ) = - \vert \frac{( {A}_{1} + {A}_{2} ) \times α ( i ) - {A}_{3} \times \vert Δ {p}_{2} ( i ) \vert}{{A}_{3}} \vert \\ {e}_{lower} ( i ) = - \vert \frac{{A}_{2} \times α ( i ) - {A}_{3} \times \vert Δ {p}_{2} ( i ) \vert}{{A}_{3}} \vert\end{matrix} \qquad ( 12 )$$

(2) Establishing the model of the thermal variation and temperature on the upper and lower surfaces of the spindle box

Equation (13) shows the model between the thermal variation and the temperature of the upper and lower surfaces of the spindle box.

$$\{ \begin{matrix}{e}_{upper} ( i ) = {a}_{1} \times Δ {t}_{1} ( i ) + {a}_{2} \\ {e}_{lower} ( i ) = {b}_{1} \times Δ {t}_{2} ( i ) + {b}_{2}\end{matrix} \qquad ( 13 )$$

Where aₗ, a₂, b₁ and b₂ are real coefficients.

The least squares method can be applied to calculate aₗ, a₂, b₁ and b₂ according to eᵤₚₚₑᵣ, e_{lower}, Δt₁ and Δt₂.

The third step is to determine the real-time thermal deformation attitude of the spindle.

During the operation of the spindle, the data of the first temperature sensor 1 and the second temperature sensor 3 are collected in a certain period (for example, 10 seconds).Then the thermal variation of the upper and lower surfaces of the spindle box (eᵤₚₚₑᵣ and e_{lower}, respectively) are calculated through equation (13). According to the following method, the thermal deformation attitude of the spindle at the current time is determined without using the displacement sensor.

The intermediate variable γ is defined in equation (14):

$$γ ( i ) = \vert \frac{{e}_{lower} ( i ) \times {A}_{1}}{{e}_{upper} ( i )} - {e}_{lower} ( i ) \vert \qquad ( 14 )$$

According to the relationship among eᵤₚₚₑᵣ, e_{lower} and γ at the current moment, the radial thermal errors (Δp_{c1} and Δp_{c2}) of the spindle at the positions of the first displacement sensor 6 and the second displacement sensor 5 at the current moment are calculated respectively according to the following conditions;

a) when eᵤₚₚₑᵣ(i)≥0, e_{lower}(i)≥0, eᵤₚₚₑᵣ(i)≥e_{lower}(i), γ(i)≤A₂:

$$\{ \begin{matrix}Δ {p}_{c 1} ( i ) = \vert \frac{( {A}_{1} + {A}_{2} + {A}_{3} ) \times ( {e}_{upper} ( i ) - {e}_{lower} ( i ) ) - {A}_{1} \times {e}_{upper } ( i )}{{A}_{1}} \vert \\ Δ {p}_{c 2} ( i ) = \vert \frac{( {A}_{1} + {A}_{2} ) \times ( {e}_{upper} ( i ) - {e}_{lower} ( i ) ) - {A}_{1} \times {e}_{upper} ( i )}{{A}_{1}} \vert\end{matrix} \qquad ( 15 )$$

b) when eᵤₚₚₑᵣ(i)>0, e_{lower}(i)<0:

$$\{ \begin{matrix}Δ {p}_{c 1} ( i ) = \vert \frac{( {A}_{1} + {A}_{2} + {A}_{3} ) \times ( {e}_{upper} ( i ) + \vert {e}_{lower} ( i ) \vert ) - {A}_{1} \times {e}_{upper} ( i )}{{A}_{1}} \vert \\ Δ {p}_{c 2} ( i ) = \vert \frac{( {A}_{1} + {A}_{2} ) \times ( {e}_{upper} ( i ) + \vert {e}_{lower} ( i ) \vert ) - {A}_{1} \times {e}_{upper} ( i )}{{A}_{1}} \vert\end{matrix} \qquad ( 16 )$$

c) when eᵤₚₚₑᵣ(i)<0, e_{lower}(i)<0, eᵤₚₚₑᵣ(i)≥e_{lower}(i):

$$\{ \begin{matrix}Δ {p}_{c 1} ( i ) = \vert \frac{( {A}_{1} + {A}_{2} + {A}_{3} ) \times ( \vert {e}_{upper} ( i ) \vert - \vert {e}_{lower} ( i ) \vert ) - {A}_{1} \times \vert {e}_{upper} ( i ) \vert}{{A}_{1}} \vert \\ Δ {p}_{c 2} ( i ) = \vert \frac{( {A}_{1} + {A}_{2} ) \times ( \vert {e}_{upper} ( i ) \vert + \vert {e}_{lower} ( i ) \vert ) - {A}_{1} \times \vert {e}_{upper} ( i ) \vert}{{A}_{1}} \vert\end{matrix} \qquad ( 17 )$$

d) when eᵤₚₚₑᵣ(i)<0, e_{lower}(i)<0, eᵤₚₚₑᵣ(i)<e_{lower}(i), γ(i)>(A₂+A₃):

$$\{ \begin{matrix}Δ {p}_{c 1} ( i ) = \vert \frac{{A}_{1} \times \vert {e}_{upper} ( i ) \vert - ( {A}_{1} + {A}_{2} + {A}_{3} ) \times ( \vert {e}_{lower} ( i ) \vert - \vert {e}_{lower} ( i ) \vert )}{{A}_{1}} \vert \\ Δ {p}_{c 2} ( i ) = \vert \frac{{A}_{1} \times \vert {e}_{upper} ( i ) \vert - ( {A}_{1} + {A}_{2} ) \times ( \vert {e}_{upper} ( i ) \vert - \vert {e}_{lower} ( i ) \vert )}{{A}_{1}} \vert\end{matrix} \qquad ( 18 )$$

e) when eᵤₚₚₑᵣ(i)≥0, e_{lower}(i)≥0, eᵤₚₚₑᵣ(i)>e_{lower}(i), γ(i)≤(A₂+A₃), γ(i)>A₂:

$$\{ \begin{matrix}Δ {p}_{c 1} ( i ) = \vert \frac{( {A}_{1} + {A}_{2} + {A}_{3} ) \times ( {e}_{upper} ( i ) - {e}_{lower} ( i ) ) - {A}_{1} \times {e}_{upper} ( i )}{{A}_{1}} \vert \\ Δ {p}_{c 2} ( i ) = - \vert \frac{{A}_{1} \times {e}_{upper} ( i ) - ( {A}_{1} + {A}_{2} ) \times ( {e}_{upper} ( i ) - {e}_{lower} ( i ) )}{{A}_{1}} \vert\end{matrix} \qquad ( 19 )$$

f) when eᵤₚₚₑᵣ(i)<0, e_{lower}(i)<0, eᵤₚₚₑᵣ(i)<e_{lower}(i), γ(i)≤(A₂+A₃), γ(i)>A₂:

$$\{ \begin{matrix}Δ {p}_{c 1} = - \vert \frac{( {A}_{1} + {A}_{2} + {A}_{3} ) \times ( \vert {e}_{upper} ( i ) \vert - \vert {e}_{lower} ( i ) \vert ) - {A}_{1} \times \vert {e}_{upper} ( i ) \vert}{{A}_{1}} \vert \\ Δ {p}_{c 2} ( i ) = \vert \frac{{A}_{1} \times \vert {e}_{upper} ( i ) \vert - ( {A}_{1} + {A}_{2} ) \times ( \vert {e}_{upper} ( i ) \vert - \vert {e}_{lower} ( i ) \vert )}{{A}_{1}} \vert\end{matrix} \qquad ( 20 )$$

g) when eᵤₚₚₑᵣ(i)≥0, e_{lower}(i)≥0, eᵤₚₚₑᵣ(i)>e_{lower}(i), γ(i)>(A₂+A₃):

$$\{ \begin{matrix}Δ {p}_{c 1} ( i ) = - \vert \frac{\begin{matrix}{A}_{1} \times {e}_{upper} ( i ) - ( {A}_{1} + {A}_{2} + {A}_{3} ) \times \\ ( {e}_{upper} ( i ) - {e}_{lower} ( i ) )\end{matrix}}{{A}_{1}} \vert \\ Δ {p}_{c 2} ( i ) = - \vert \frac{\begin{matrix}{A}_{1} \times {e}_{upper} ( i ) - ( {A}_{1} + {A}_{2} ) \times \\ ( {e}_{upper} ( i ) - {e}_{lower} ( i ) )\end{matrix}}{{A}_{1}} \vert\end{matrix} \qquad ( 21 )$$

h) when eᵤₚₚₑᵣ(i)≥0, e_{lower}(i)≥0, eᵤₚₚₑᵣ(i)≤e_{lower}(i):

$$\{ \begin{matrix}Δ {p}_{c 1} ( i ) = - \vert \frac{\begin{matrix}{A}_{1} \times {e}_{upper} ( i ) - ( {A}_{1} + {A}_{2} + {A}_{3} ) \times \\ ( {e}_{upper} ( i ) - {e}_{lower} ( i ) )\end{matrix}}{{A}_{1}} \vert \\ Δ {p}_{c 2} ( i ) = - \vert \frac{\begin{matrix}{A}_{1} \times {e}_{upper} ( i ) - ( {A}_{1} + {A}_{2} ) \times \\ ( {e}_{upper} ( i ) - {e}_{lower} ( i ) )\end{matrix}}{{A}_{1}} \vert\end{matrix} \qquad ( 22 )$$

i) when eᵤₚₚₑᵣ(i)<0, e_{lower}(i)>0:

$$\{ \begin{matrix}Δ {p}_{c 1} ( i ) = - \vert \frac{\begin{matrix}( {A}_{1} + {A}_{2} + {A}_{3} ) \times \\ ( \vert {e}_{upper} ( i ) \vert + {e}_{lower} ( i ) ) - {A}_{1} \times \vert {e}_{upper} ( i ) \vert\end{matrix}}{{A}_{1}} \vert \\ Δ {p}_{c 2} ( i ) = - \vert \frac{\begin{matrix}( {A}_{1} + {A}_{2} ) \times \\ ( \vert {e}_{upper} ( i ) \vert + {e}_{lower} ( i ) ) - {A}_{1} \times \vert {e}_{upper} ( i ) \vert\end{matrix}}{{A}_{1}} \vert\end{matrix} \qquad ( 23 )$$

j) when eᵤₚₚₑᵣ(i)<0, e_{lower}(i)<0, eᵤₚₚₑᵣ(i)≤e_{lower}(i), γ(i)≤A₂:

$$\{ \begin{matrix}Δ {p}_{c 1} ( i ) = - \vert \frac{\begin{matrix}( {A}_{1} + {A}_{2} + {A}_{3} ) \times \\ ( \vert {e}_{upper} ( i ) \vert - \vert {e}_{lower} ( i ) \vert ) - {A}_{1} \times \vert {e}_{upper} ( i ) \vert\end{matrix}}{{A}_{1}} \vert \\ Δ {p}_{c 2} ( i ) = - \vert \frac{\begin{matrix}( {A}_{1} + {A}_{2} ) \times \\ ( \vert {e}_{upper} ( i ) \vert - \vert {e}_{lower} ( i ) \vert ) - {A}_{1} \times \vert {e}_{upper} ( i ) \vert\end{matrix}}{{A}_{1}} \vert\end{matrix} \qquad ( 24 )$$

According to Δp_{c1} and Δp_{c2}, the thermal deformation attitude of the spindle, including the radial thermal error Eₜₕₑᵣₘₐₗ and the thermal tilt error φₜₕₑᵣₘₐₗ of the spindle, can be calculated through equation (25).

$$\{ \begin{matrix}{E}_{thermal} ( i ) = Δ {p}_{c 2} ( i ) \\ {ϕ}_{thermal} ( i ) = arctan ( \frac{Δ {p}_{c 1} ( i ) - Δ {p}_{c 2} ( i )}{{A}_{3}} )\end{matrix} \qquad ( 25 )$$

The invention has the beneficial effects to realize real-time monitoring of the thermal deformation attitude of the spindle during the machining process. It should be indicated that there is no such a real-time monitoring method for the thermal deformation attitude of the spindle during the machining. The invention can realize real-time monitoring of the thermal deformation attitude of the spindle during the machining process of the machine tool, thereby judging whether the current state of the spindle can meet the machining precision requirement of the workpiece, avoiding the over-tolerance of the machining accuracy and improving the product qualification rate. The real-time monitoring method can also provide a basis for the analysis, modeling and compensation of the spindle thermal deformation mechanism.

### DRAWINGS

FIG. 1 is a schematic diagram of the temperature sensor arrangement and the spindle thermal deformation attitude test.

FIG. 2 is a flowchart of the real-time thermal deformation attitude of the spindle.

FIG. 3 shows the temperatures collected by the first and second temperature sensors.

FIG. 4 shows the displacements acquired by the first and second displacement sensors.

FIG. 5(a) shows the predicted spindle radial thermal error.

FIG. 5(b) shows the predicted thermal tilt error of the spindle.

In the figure: 1 first temperature sensor; 2 spindle box; 3 second temperature sensor; 4 bar; 5 second displacement sensor; 6 first displacement sensor.

### DETAILED DESCRIPTION

In order to clarify the objects, technical solutions and advantages of the present invention, the present invention is described in detail with reference to the accompanying drawings.

An embodiment of this invention is described in detail by employing a certain type of three-axis vertical machining center with the maximum spindle speed of 15000 rpm. The spindle motor and the spindle are connected by a coupling, and the spindle is not equipped with a cooling device.

First Step, Temperature And Thermal Error Testing

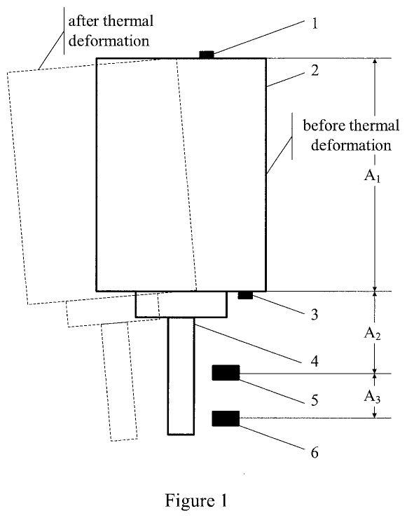

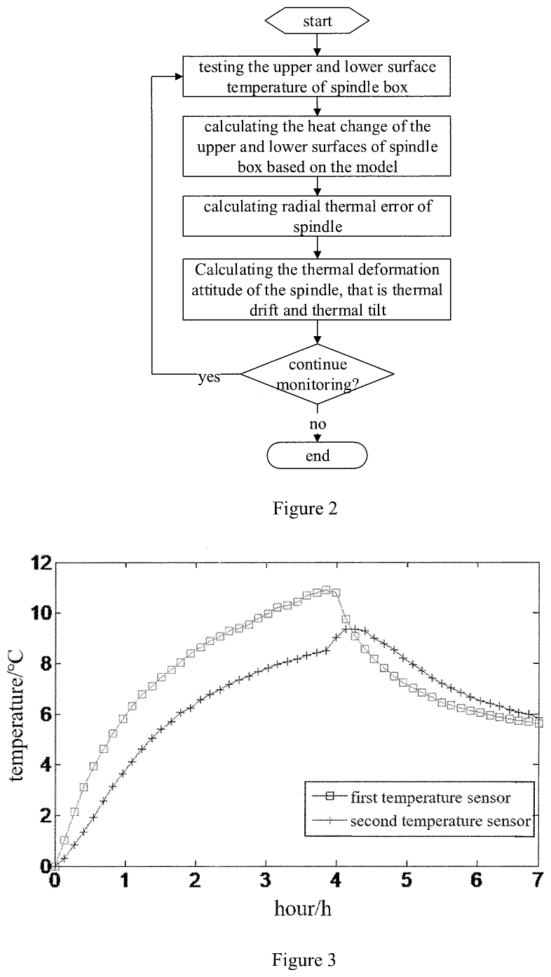

The first temperature sensor (1) is located on the upper surface of the spindle box (2), while the second temperature sensor (3) is located on the lower surface of the spindle box (2). Moreover, the bar (4) is fixed to the spindle through the shank interface. The first displacement sensor (6) and the second displacement sensor (5) are installed on the side of the bar (4), wherein the second displacement sensor (5) is close to the nose end of the spindle. FIG. 1 shows the configuration of the sensors.

The testing process is as follows: Firstly, the spindle is continuously heated by running 4 hours at the speed of 8000 rpm, and then the spindle stops rotating for 3 hours. In this process, the data of the first temperature sensor 1, the second temperature sensor 3, the first displacement sensor 6 and the second displacement sensor 5 are collected in 10 s cycle.

The second step is to establish the model of thermal variation and the temperature of the upper and lower surfaces of the spindle box.

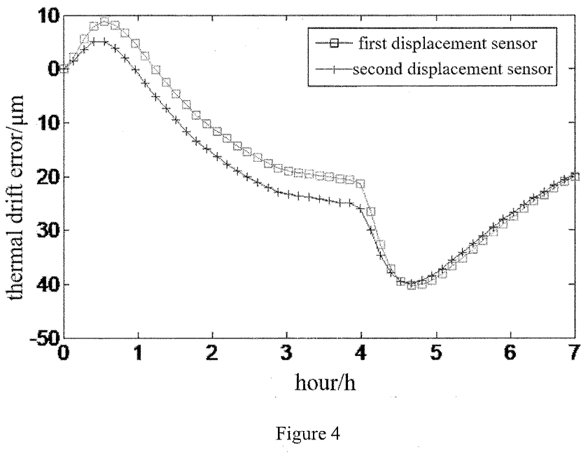

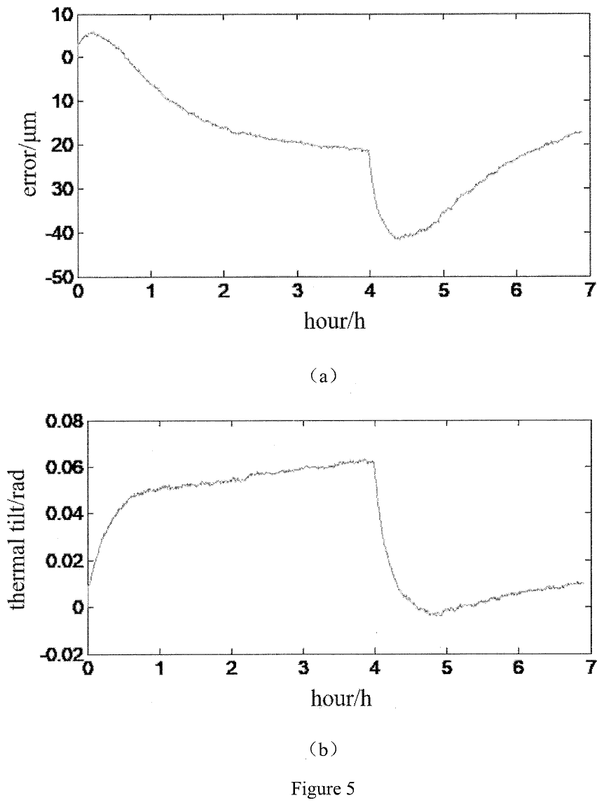

The collected data from the first temperature sensor (1) and second temperature sensor (2) are called t₁ and t₂, respectively. Moreover, the collected data from the first displacement sensor (6) and second displacement sensor (5) are presented by p₁ and p₂, respectively. The increment of t₁, t₂, p₁ and p₂ are calculated through equation (1). FIG. 3 illustrates the distribution of Δt₁ and Δt₂, while the distributions of Δp₁ and Δp₂ are presented in FIG. 4.

The distance from the upper surface to the lower surface of the spindle box (2) is 210 mm, while the distance from the lower surface of spindle box (2) to the second displacement sensor (5) is 280 mm. Moreover, the distance from the second displacement sensor (5) to the first displacement sensor (6) is 76.2 mm.

According to the spindle structure and the obtained Δp₁ and Δp₂, the upper surface thermal variation eᵤₚₚₑᵣ and the lower surface thermal variation e_{lower} of the spindle box can be calculated through equations (2)-(12). Furthermore, the least squares method is applied to equation (13) to calculate the coefficients a₁, a₂, b₁, and b₂, where the obtained coefficients are 5.76, 0.37, 4.85 and −0.08, respectively.

The third step is to determine the real-time thermal deformation attitude of the spindle

The spindle is continuously heated by running 4 hours at the speed of 10000 rpm. Then the spindle stops rotating for 3 hours. In this process, the data of the first temperature sensor (1) and the second temperature sensor (3) are collected in 10 s cycles. Then equation (13) is employed to calculate the thermal variation of the upper and lower surfaces of the spindle box (eᵤₚₚₑᵣ and e_{lower}, respectively) according to the real time temperature data at the current time.

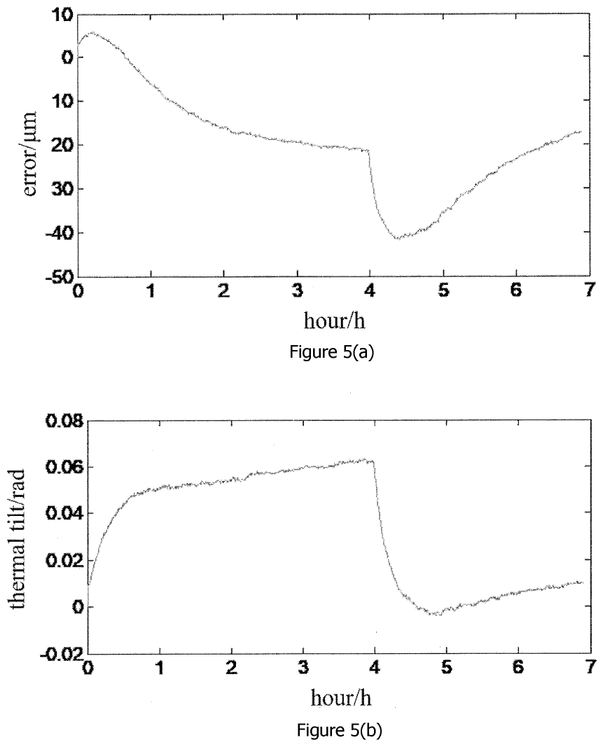

The thermal deformation attitude of the spindle, including the radial thermal error (as shown in FIG. 5(a)) and the thermal tilt error (as shown in FIG. 5(b)) of the spindle, is calculated through equations (14) to (25). Thus, the real-time thermal deformation attitude of the spindle is determined.

1. A method for determining the real-time thermal deformation attitude of a spindle, firstly, a temperature and a displacement sensors are applied to determine temperature of upper and lower surfaces of a spindle box and radial thermal error of running spindle, respectively; then, thermal variation of the upper and lower surfaces of the spindle box is calculated in accordance with the radial thermal error of the spindle, and a model for the thermal variation and the temperature of the upper and lower surfaces of the spindle box is established; finally, the established model is employed to determine a real-time thermal deformation attitude of the spindle, according to the real-time temperatures of the upper and lower surface of the spindle box; wherein, the steps are as follows:
step 1: temperature and thermal error testing
a first temperature sensor (1) is located on the upper surface of the spindle box (2), a second temperature sensor (3) is located on the lower surface of the spindle box (2); and moreover, a bar (4) is fixed to the spindle through shank interface; a first displacement sensor (6) and a second displacement sensor (5) are installed on the side of the bar (4), wherein the second displacement sensor (5) is close to the nose end of the spindle;
the testing process are as follows: firstly, the spindle is continuously heated by running M hours at the speed of R, and then the spindle stops rotating for N hours; in this process, the data obtained from the first temperature sensor (1), the second temperature sensor (3), the first displacement sensor (6) and the second displacement sensor (5) are collected in a certain period;
the second step is to establish the model for the thermal variation and the temperature of the upper and lower surfaces of the spindle box;
the collected data from the first temperature sensor (1) and second temperature sensor (3) are called t₁ and t₂, respectively; the collected data from the first displacement sensor (6) and second displacement sensor (5) are represented by p₁ and p₂, respectively; the increment of t₁, t₂, p₁ and p₂ are expressed in equation (1);
$$\{ \begin{matrix}Δ {t}_{1} ( i ) = {t}_{1} ( i ) - {t}_{1} ( 1 ) \\ Δ {t}_{2} ( i ) = {t}_{2} ( i ) - {t}_{2} ( 1 ) \\ Δ {p}_{1} ( i ) = {p}_{1} ( i ) - {p}_{1} ( 1 ) \\ Δ {p}_{2} ( i ) = {p}_{2} ( i ) - {p}_{2} ( 1 )\end{matrix} \qquad ( 1 )$$
assume that the distance from the upper surface to the lower surface of the spindle box (2) is A₁, while the distance from the lower surface of spindle box (2) to the second displacement sensor is A₂; assume that the distance from the second displacement sensor (5) to the first displacement sensor (6) is A₃;
(1) calculate the thermal expansion amount of the upper and lower surfaces of the spindle box;
according to the spindle structure, Δp₁ and Δp₂, the thermal variation of the upper surface eᵤₚₚₑᵣ and that of the lower surface e_{lower} can be calculated through the following method;
intermediate variables α and β are defined as:
$$\{ \begin{matrix}α ( i ) = Δ {t}_{1} ( i ) - Δ {t}_{2} ( i ) \\ β ( i ) = \vert \frac{{A}_{3} \times Δ {t}_{2} ( i )}{α ( i )} \vert\end{matrix} \qquad ( 2 )$$
according to the relationship between α, β, Δp₁ and Δp₂ at the current time, the thermal variation on the upper and lower surfaces of the spindle box at the current time is calculated as follows;
a) when Δp₁(i)≥0, Δp₂(i)≥0, Δp₁(i)>Δp₂(i), β(i)≤A₂:
$$\{ \begin{matrix}{e}_{upper} ( i ) = \vert \frac{( {A}_{1} + {A}_{2} ) \times α ( i ) - {A}_{3} \times Δ {p}_{2} ( i )}{{A}_{3}} \vert \\ {e}_{lower} ( i ) = \vert \frac{{A}_{2} \times α ( i ) - {A}_{3} \times Δ {p}_{2} ( i )}{{A}_{3}} \vert\end{matrix} \qquad ( 3 )$$
b) when Δp₁(i)≥0, Δp₂(i)≥0, Δp₁(i)>Δp₂(i), β(i)>A₂, β(i)≤(A₁+A₂):
$$\{ \begin{matrix}{e}_{upper} ( i ) = \vert \frac{( {A}_{1} + {A}_{2} ) \times α ( i ) - {A}_{3} \times Δ {p}_{2} ( i )}{{A}_{3}} \vert \\ {e}_{lower} ( i ) = - \vert \frac{{A}_{3} \times Δ {p}_{2} ( i ) - {A}_{2} \times α ( i )}{{A}_{3}} \vert\end{matrix} \qquad ( 4 )$$
c) when Δp₁(i)≥0, Δp₂(i)≥0, Δp₁(i)>Δp₂(i), β(i)>(A₁+A₂):
$$\{ \begin{matrix}{e}_{upper} ( i ) = - \vert \frac{{A}_{3} \times Δ {p}_{2} ( i ) - ( {A}_{1} + {A}_{2} ) \times α ( i )}{{A}_{3}} \vert \\ {e}_{lower} ( i ) = - \vert \frac{{A}_{3} \times Δ {p}_{2} ( i ) - {A}_{2} \times α ( i )}{{A}_{3}} \vert\end{matrix} \qquad ( 5 )$$
d) when Δp₁(i)≥0, Δp₂(i)≥0, Δp₁(i)≤Δp₂(i):
$$\{ \begin{matrix}{e}_{upper} ( i ) = - \vert \frac{{A}_{3} \times Δ {p}_{2} ( i ) + ( {A}_{1} + {A}_{2} ) \times α ( i )}{{A}_{3}} \vert \\ {e}_{lower} ( i ) = - \vert \frac{{A}_{3} \times Δ {p}_{2} ( i ) + {A}_{2} \times α ( i )}{{A}_{3}} \vert\end{matrix} \qquad ( 6 )$$
e) when Δp₁(i)>0, Δp₂(i)<0:
$$\{ \begin{matrix}{e}_{upper} ( i ) = \vert \frac{{A}_{3} \times \vert Δ {p}_{2} ( i ) \vert + ( {A}_{1} + {A}_{2} ) \times α ( i )}{{A}_{3}} \vert \\ {e}_{lower} ( i ) = \vert \frac{{A}_{3} \times \vert Δ {p}_{2} ( i ) \vert + {A}_{2} \times α ( i )}{{A}_{3}} \vert\end{matrix} \qquad ( 7 )$$
f) when Δp₁(i)<0, Δp₂(i)>0:
$$\{ \begin{matrix}{e}_{upper} ( i ) = - \vert \frac{{A}_{3} \times Δ {p}_{2} ( i ) + ( {A}_{1} + {A}_{2} ) \times α ( i )}{{A}_{3}} \vert \\ {e}_{lower} ( i ) = - \vert \frac{{A}_{3} \times Δ {p}_{2} ( i ) + {A}_{2} \times α ( i )}{{A}_{3}} \vert\end{matrix} \qquad ( 8 )$$
g) when Δp₁(i)<0, Δp₂(i)<0, Δp₁(i)≥Δp₂(i):
$$\{ \begin{matrix}{e}_{upper} ( i ) = \vert \frac{{A}_{3} \times \vert Δ {p}_{2} ( i ) \vert + ( {A}_{1} + {A}_{2} ) \times α ( i )}{{A}_{3}} \vert \\ {e}_{lower} ( i ) = \vert \frac{{A}_{3} \times \vert Δ {p}_{2} ( i ) \vert + {A}_{2} \times α ( i )}{{A}_{3}} \vert\end{matrix} \qquad ( 9 )$$
h) when Δp₁(i)<0, Δp₂(i)<0, Δp₁(i)<Δp₂(i), β(i)>(A₁+A₂):
$$\{ \begin{matrix}{e}_{upper} ( i ) = \vert \frac{{A}_{3} \times \vert Δ {p}_{2} ( i ) \vert - ( {A}_{1} + {A}_{2} ) \times α ( i )}{{A}_{3}} \vert \\ {e}_{lower} ( i ) = \vert \frac{{A}_{3} \times \vert Δ {p}_{2} ( i ) \vert - {A}_{2} \times α ( i )}{{A}_{3}} \vert\end{matrix} \qquad ( 10 )$$
i) when Δp₁(i)<0, Δp₂(i)<0, Δp₁(i)<Δp₂(i), β(i)<(A₁+A₂), β(i)>A₂:
$$\{ \begin{matrix}{e}_{upper} ( i ) = - \vert \frac{( {A}_{1} + {A}_{2} ) \times α ( i ) - {A}_{3} \times \vert Δ {p}_{2} ( i ) \vert}{{A}_{3}} \vert \\ {e}_{lower} ( i ) = \vert \frac{{A}_{3} \times \vert Δ {p}_{2} ( i ) \vert - {A}_{2} \times α ( i )}{{A}_{3}} \vert\end{matrix} \qquad ( 11 )$$
j) when Δp₁(i)<0, Δp₂(i)<0, Δp₁(i)<Δp₂(i), β(i)≤A₂:
$$\{ \begin{matrix}{e}_{upper} ( i ) = - \vert \frac{( {A}_{1} + {A}_{2} ) \times α ( i ) - {A}_{3} \times \vert Δ {p}_{2} ( i ) \vert}{{A}_{3}} \vert \\ {e}_{lower} ( i ) = - \vert \frac{{A}_{2} \times α ( i ) - {A}_{3} \times \vert Δ {p}_{2} ( i ) \vert}{{A}_{3}} \vert\end{matrix} \qquad ( 12 )$$
(2) establishing the model of the thermal variation and temperature on the upper and lower surfaces of the spindle box
equation (13) shows the model between the thermal variation and the temperature of the upper and lower surfaces of the spindle box:
$$\{ \begin{matrix}{e}_{upper} ( i ) = {a}_{1} \times Δ {t}_{1} ( i ) + {a}_{2} \\ {e}_{lower} ( i ) = {b}_{1} \times Δ {t}_{2} ( i ) + {b}_{2}\end{matrix} \qquad ( 13 )$$
where a₁, a₂, b₁ and b₂ are real coefficients;
the least squares method can be applied to calculate a₁, a₂, b₁ and b₂ according to eᵤₚₚₑᵣ, e_{lower}, Δt₁ and Δt₂;
the third step is to determine the real-time thermal deformation attitude of the spindle
during the operation of the spindle, the data of the first temperature sensor (1) and the second temperature sensor (3) are collected in a certain period, for example, 10 seconds; then the thermal variation of the upper and lower surfaces of the spindle box, eᵤₚₚₑᵣ and e_{lower}, respectively, are calculated through equation (13); according to the following method, the thermal deformation attitude of the spindle at the current time is determined without using the displacement sensor;
the intermediate variable γ is defined in equation (14):
$$γ ( i ) = \vert \frac{{e}_{lower} ( i ) \times {A}_{1}}{{e}_{upper} ( i )} - {e}_{lower} ( i ) \vert \qquad ( 14 )$$
according to the relationship among eᵤₚₚₑᵣ, e_{lower} and γ at the current moment, the radial thermal errors (Δp_{c1} and Δp_{c2}) of the spindle at the positions of the first displacement sensor (6) and the second displacement sensor (5) at the current moment are calculated respectively according to the following conditions;
a) when eᵤₚₚₑᵣ(i)≥0, e_{lower}(i)≥0, e^{upper}(i)≥e_{lower}(i), γ(i)≤A₂:
$$\{ \begin{matrix}Δ {p}_{c 1} ( i ) = \vert \frac{( {A}_{1} + {A}_{2} + {A}_{3} ) \times ( {e}_{upper} ( i ) - {e}_{lower} ( i ) ) - {A}_{1} \times {e}_{upper} ( i )}{{A}_{1}} \vert \\ Δ {p}_{c 2} ( i ) = \vert \frac{( {A}_{1} + {A}_{2} ) \times ( {e}_{upper} ( i ) - {e}_{lower} ( i ) ) - {A}_{1} \times {e}_{upper} ( i )}{{A}_{1}} \vert\end{matrix} \qquad ( 15 )$$
b) when eᵤₚₚₑᵣ(i)>0, e_{lower}(i)<0:
$$\{ \begin{matrix}Δ {p}_{c 1} ( i ) = \vert \frac{( {A}_{1} + {A}_{2} + {A}_{3} ) \times ( {e}_{upper} ( i ) + \vert {e}_{lower} ( i ) \vert ) - {A}_{1} \times {e}_{upper} ( i )}{{A}_{1}} \vert \\ Δ {p}_{c 2} ( i ) = \vert \frac{( {A}_{1} + {A}_{2} ) \times ( {e}_{upper} ( i ) + \vert {e}_{lower} ( i ) \vert ) - {A}_{1} \times {e}_{upper} ( i )}{{A}_{1}} \vert\end{matrix} \qquad ( 16 )$$
c) when eᵤₚₚₑᵣ(i)<0, e_{lower}(i)<0, eᵤₚₚₑᵣ(i)≥e_{lower}(i):
$$\{ \begin{matrix}Δ {p}_{c 1} ( i ) = \vert \frac{( {A}_{1} + {A}_{2} + {A}_{3} ) \times ( \vert {e}_{upper} ( i ) \vert - \vert {e}_{lower} ( i ) \vert ) + {A}_{1} \times \vert {e}_{upper} ( i ) \vert}{{A}_{1}} \vert \\ Δ {p}_{c 2} ( i ) = \vert \frac{( {A}_{1} + {A}_{2} ) \times ( \vert {e}_{upper} ( i ) \vert - \vert {e}_{lower} ( i ) \vert ) + {A}_{1} \times \vert {e}_{upper} ( i ) \vert}{{A}_{1}} \vert\end{matrix} \qquad ( 17 )$$
d) when eᵤₚₚₑᵣ(i)<0, e_{lower}(i)<0, eᵤₚₚₑᵣ(i)<e_{lower}(i), γ(i)>(A₂+A₃):
$$\{ \begin{matrix}Δ {p}_{c 1} ( i ) = \vert \frac{{A}_{1} \times \vert {e}_{upper} ( i ) \vert - ( {A}_{1} + {A}_{2} + {A}_{3} ) \times ( \vert {e}_{upper} ( i ) \vert - \vert {e}_{lower} ( i ) \vert )}{{A}_{1}} \vert \\ Δ {p}_{c 2} ( i ) = \vert \frac{{A}_{1} \times \vert {e}_{upper} ( i ) \vert - ( {A}_{1} + {A}_{2} ) \times ( \vert {e}_{upper} ( i ) \vert - \vert {e}_{lower} ( i ) \vert )}{{A}_{1}} \vert\end{matrix} \qquad ( 18 )$$
e) when eᵤₚₚₑᵣ(i)≥0, e_{lower}(i)≥0, eᵤₚₚₑᵣ(i)>e_{lower}(i), γ(i)≤(A₂+A₃), γ(i)>A₂:
$$\{ \begin{matrix}Δ {p}_{c 1} ( i ) = \vert \frac{( {A}_{1} + {A}_{2} + {A}_{3} ) \times ( {e}_{upper} ( i ) - {e}_{lower} ( i ) ) - {A}_{1} \times {e}_{upper} ( i )}{{A}_{1}} \vert \\ Δ {p}_{c 2} ( i ) = - \vert \frac{{A}_{1} \times {e}_{upper} ( i ) - ( {A}_{1} + {A}_{2} ) \times ( {e}_{upper} ( i ) - {e}_{lower} ( i ) )}{{A}_{1}} \vert\end{matrix} \qquad ( 19 )$$
f) when eᵤₚₚₑᵣ(i)<0, e_{lower}(i)<0, eᵤₚₚₑᵣ(i)<e_{lower}(i), γ(i)≤(A₂+A₃), γ(i)>A₂:
$$\{ \begin{matrix}Δ {p}_{c 1} ( i ) = - \vert \frac{( {A}_{1} + {A}_{2} + {A}_{3} ) \times ( \vert {e}_{upper} ( i ) \vert - \vert {e}_{lower} ( i ) \vert ) - {A}_{1} \times \vert {e}_{upper} ( i ) \vert}{{A}_{1}} \vert \\ Δ {p}_{c 2} ( i ) = \vert \frac{{A}_{1} \times \vert {e}_{upper} ( i ) \vert - ( {A}_{1} + {A}_{2} ) \times ( \vert {e}_{upper} ( i ) \vert - \vert {e}_{lower} ( i ) \vert )}{{A}_{1}} \vert\end{matrix} \qquad ( 20 )$$
g) when eᵤₚₚₑᵣ(i)≥0, e_{lower}(i)≥0, eᵤₚₚₑᵣ(i)>e_{lower}(i), γ(i)>(A₂+A₃):
$$\{ \begin{matrix}Δ {p}_{c 1} ( i ) = - \vert \frac{{A}_{1} \times {e}_{upper} ( i ) - ( {A}_{1} + {A}_{2} + {A}_{3} ) \times ( {e}_{upper} ( i ) - {e}_{lower} ( i ) )}{{A}_{1}} \vert \\ Δ {p}_{c 2} ( i ) = - \vert \frac{{A}_{1} \times {e}_{upper} ( i ) - ( {A}_{1} + {A}_{2} ) \times ( {e}_{upper} ( i ) - {e}_{lower} ( i ) )}{{A}_{1}} \vert\end{matrix} \qquad ( 21 )$$
h) when eᵤₚₚₑᵣ(i)≥0, e_{lower}(i)≥0, eᵤₚₚₑᵣ(i)≤e_{lower}(i):
$$\{ \begin{matrix}Δ {p}_{c 1} ( i ) = - \vert \frac{{A}_{1} \times {e}_{upper} ( i ) - ( {A}_{1} + {A}_{2} + {A}_{3} ) \times ( {e}_{upper} ( i ) - {e}_{lower} ( i ) )}{{A}_{1}} \vert \\ Δ {p}_{c 2} ( i ) = - \vert \frac{{A}_{1} \times {e}_{upper} ( i ) - ( {A}_{1} + {A}_{2} ) \times ( {e}_{upper} ( i ) - {e}_{lower} ( i ) )}{{A}_{1}} \vert\end{matrix} \qquad ( 22 )$$
i) when eᵤₚₚₑᵣ(i)<0, e_{lower}(i)>0:
$$\{ \begin{matrix}Δ {p}_{c 1} ( i ) = - \vert \frac{( {A}_{1} + {A}_{2} + {A}_{3} ) \times ( \vert {e}_{upper} ( i ) \vert + {e}_{lower} ( i ) ) - {A}_{1} \times \vert {e}_{upper} ( i ) \vert}{{A}_{1}} \vert \\ Δ {p}_{c 2} ( i ) = - \vert \frac{( {A}_{1} + {A}_{2} ) \times ( \vert {e}_{upper} ( i ) \vert + {e}_{lower} ( i ) ) - {A}_{1} \times \vert {e}_{upper} ( i ) \vert}{{A}_{1}} \vert\end{matrix} \qquad ( 23 )$$
j) when eᵤₚₚₑᵣ(i)<0, e_{lower}(i)<0, eᵤₚₚₑᵣ(i)≤e_{lower}(i), γ(i)≤A₂:
$$\{ \begin{matrix}Δ {p}_{c 1} ( i ) = - \vert \frac{( {A}_{1} + {A}_{2} + {A}_{3} ) \times ( \vert {e}_{upper} ( i ) \vert - \vert {e}_{lower} ( i ) \vert ) - {A}_{1} \times \vert {e}_{upper} ( i ) \vert}{{A}_{1}} \vert \\ Δ {p}_{c 2} ( i ) = - \vert \frac{( {A}_{1} + {A}_{2} ) \times ( \vert {e}_{upper} ( i ) \vert - \vert {e}_{lower} ( i ) \vert ) - {A}_{1} \times \vert {e}_{upper} ( i ) \vert}{{A}_{1}} \vert\end{matrix} \qquad ( 24 )$$
according to Δp_{c1} and Δp_{c2}, the thermal deformation attitude of the spindle, including the radial thermal error Eₜₕₑᵣₘₐₗ and the thermal tilt error φₜₕₑᵣₘₐₗ of the spindle, can be calculated through equation (25);
$$\{ \begin{matrix}{E}_{thermal} ( i ) = Δ {p}_{c 2} ( i ) \\ {ϕ}_{thermal} ( i ) = arctan ( \frac{Δ {p}_{c 1} ( i ) - Δ {p}_{c 2} ( i )}{{A}_{3}} )\end{matrix} . \qquad ( 25 )$$
